(19) United States
(12) Patent Application Publication
(10) Pub. No.: US 2006/0140125 A1
(43) Pub. Date: Jun. 29, 2006

(54) Hybrid test bed

(75) Inventors: Robert C. Ottinger, La Jolla, CA (US); Srinivasan Balasubramanian, San Diego, CA (US)

Correspondence Address: COATS & BENNETT, PLLC, P O BOX 5, RALEIGH, NC, 27602, US

(73) Assignee: Telefonaktiebolaget LM Ericsson

(21) Appl. No.: 11/021,172

(22) Filed: Dec. 23, 2004

(51) Int. Cl. H04B 7/00; H04J 1/16; H04L 12/26

(52) U.S. Cl. 370/241; 370/310

(57) ABSTRACT

A hybrid test bed mixes simulated and actual wireless communication network entities in a real-time packet data simulation. In at least one embodiment, the test bed supports end-to-end simulation for a packet data application running on a mobile station simulator. The test bed provides a realistic assessment of that application's real-time performance by constraining packet data transmissions from a radio base station simulator to the mobile station simulator according to peak data throughput estimates and mobility event processing determined from a detailed wireless communication network simulation. Additionally, the test bed includes or is associated with a graphical display system providing real-time performance information.

### BACKGROUND OF THE INVENTION

The present invention generally relates to wireless communication networks, and particularly relates to wireless communication network simulations.

Simulations permit testing individual devices, or even whole systems, before the devices or systems are built. In many cases involving the design of complex systems, the individual pieces of the system become available at different times and simulating the unavailable pieces permits evaluating the overall system before all of its elements actually exist.

Wireless communication networks pose significant design and evaluation challenges because of their inherent complexity and unwieldiness. Simulation therefore plays a vital role in wireless communication system development. However, conventional approaches to wireless network simulation tend either to favor detailed simulations of radio link performance without much in the way of higher layer application testing, or simulations of higher-layer operations without the underlying detailed radio link simulations.

The inability to meld these two approaches to simulation takes on greater significance as the current and planned wireless communication networks further extend their high-rate packet data capabilities. For example, end-to-end packet data applications depend on extra-network entities such as IP-based media servers, as well as network-based entities, such as Packet Data Serving Nodes, Packet Control Functions, Base Station Controllers, etc., all the way out to the mobile stations, with their supporting hardware and software.

### SUMMARY OF THE INVENTION

The present invention comprises a method and apparatus for simulating end-to-end packet data services for a wireless communication network. A “hybrid” test bed mixes simulated and actual wireless communication network entities in a real-time packet data simulation. In at least one embodiment, the test bed supports end-to-end simulation for a packet data application running on a mobile station simulator. The test bed provides a realistic assessment of real-time performance by constraining packet data transmissions between a radio base station simulator and the mobile station simulator according to peak data throughput estimates and mobility event processing determined from a detailed wireless communication network simulation. Additionally, the test bed includes or is associated with a graphical display system providing real-time performance information.

Thus, in one or more embodiments, the present invention comprises a method of realistically simulating the end-to-end performance of packet data applications in real-time for a wireless communication network. That method comprises running a packet data application in real-time on a mobile station simulator that is coupled to a radio base station simulator through a simulated air interface, coupling the radio base station simulator through an actual base station controller to an actual packet data server supporting the packet data application in real-time, and imposing realistic performance constraints on the simulated air interface. One method of imposing performance constraints on the air interface comprises constraining real-time packet data transmissions from the radio base station simulator for the packet data application according to detailed air interface simulation data.

For example, the method may comprise constraining the real-time packet data transmissions from the radio base station simulator according to sequences of peak data throughput estimates and mobility events corresponding to movement by the (simulated) mobile station along a hypothesized path of travel within a wireless communication network simulation that incorporates a defined radio base station layout, corresponding radio propagation channel models, etc. A detailed simulation of radio transmission conditions can be played out for a given route of travel within the simulated network environment, and packet data throughputs and mobility events can be computed and/or identified at timed intervals along that path. As such, serving sector (active set changes), cell handovers, etc., and changing radio conditions—specified by peak throughput limits, for example—can be communicated to the radio base station simulator, so that packet data being transmitted in real-time for the packet data application(s) running at the mobile station simulator can be constrained to reflect expected real-world performance.

The detailed simulation data can be generated on the fly by a simulation controller, or can be generated off-line in advance of running the real-time simulation. In the latter case, the real-time simulation's packet data performance is constrained by “playing back” the detailed air interface simulation results in real-time. In either case, the simulation controller provides constraint information in the form of peak data throughput estimates and mobility event information to the simulated radio base station at timed intervals, e.g., every 20 milliseconds. The simulated radio base station uses that information to control transmission of real-time packet data to the mobile station simulator, so that the packet data application running at the mobile station simulator reflects a more realistic performance scenario. Generally, the detailed radio link simulation information can be used to update real-time packet data delivery at time intervals from about 10 milliseconds to about 100 milliseconds.

According to one or more embodiments of the present invention, then, a hybrid test bed mixes actual and simulated wireless communication network entities, and realistically simulates the end-to-end performance of packet data applications in real-time. In one or more embodiments, the test bed comprises a mobile station simulator, a radio base station simulator, an actual base station controller, an actual packet data server, and a simulation controller, which may have a simulation control interface communicatively coupling it to the radio base station simulator. The simulation controller can be an appropriately configured Personal Computer, rack-mounted processing platform, or other type of computer system.

The mobile station simulator is configured to run a packet data application in real-time, and the radio base station simulator is communicatively coupled to it through a simulated air interface. The base station controller is coupled to the radio base simulator and communicatively coupled to the packet data server, which is configured to support the packet data application in real-time. The simulation controller communicates with the radio base station simulator via the simulation control interface and is configured to impose realistic performance constraints on the simulated air interface. It does so by constraining real-time packet data transmissions from the radio base station simulator for the packet data application according to detailed air interface simulation data that the simulation controller generates on the fly or, preferably, reads from data files generated from a prior detailed air interface simulation done for a given network configuration of interest.

For example, the simulation controller can be configured to generate the sequence of peak data throughput estimates for the mobile station by estimating packet data throughput to the mobile station at timed intervals corresponding to mobile station movement along the hypothesized path of travel for a full-buffer data transmission scenario in a detailed radio environment simulation. Alternatively, the simulation controller can read such data from one or more simulation files generated in advance of the real-time simulation.

In one or more embodiments, the hybrid test bed includes a mobile-side modem simulator in the mobile station simulator, and includes a cell-side modem simulator in the radio base station simulator. These mobile-side and cell-side modem simulators can comprise one or more microprocessor-based circuits executing computer program instructions corresponding to hardware-based implementations of actual cell-side and mobile-side modems. Providing modem simulators to support end-to-end packet data application offers several advantages, including providing the ability to test various elements in the end-to-end path, such as the base station controller and/or packet data server, without requiring the actual modem hardware.

Of course, the present invention is not limited to the above features and advantages. Indeed, those skilled in the art will appreciate additional features and advantages of the present invention upon reading the following description, and upon viewing the accompanying drawings.

### BRIEF DESCRIPTION OF THE DRAWINGS

FIG. 1 is a block diagram of a hybrid test bed 10 according to one or more embodiments of the present invention.

FIG. 2 is another block diagram of the hybrid test bed.

FIG. 3 is a more detailed block diagram of the hybrid test bed for a given simulation configuration, and for a given set of simulation files.

FIGS. 4 and 5 are diagrams of simulated over-the-air packet data service transmissions for a F-PDCH and a R-PDCH, respectively.

FIGS. 6 and 7 illustrate the simulation-controlled delivery and dropping of selected packet data for two simulated mobile stations, MS1 and MS2, where data is dropped or delivered according to detailed air link performance simulation data.

FIGS. 8 and 9 illustrate simulation-controlled cell switches and active set changes for one or more simulated mobile stations, as determined by a detailed air interface simulation for a given simulated radio network layout.

FIG. 10 illustrates simulation-controlled soft and softer handoff events.

FIG. 11 illustrates operation of a simulation mechanism of the hybrid test bed 10 that provides advance notification of simulation-controlled cell switching and active set change events.

### DETAILED DESCRIPTION OF THE INVENTION

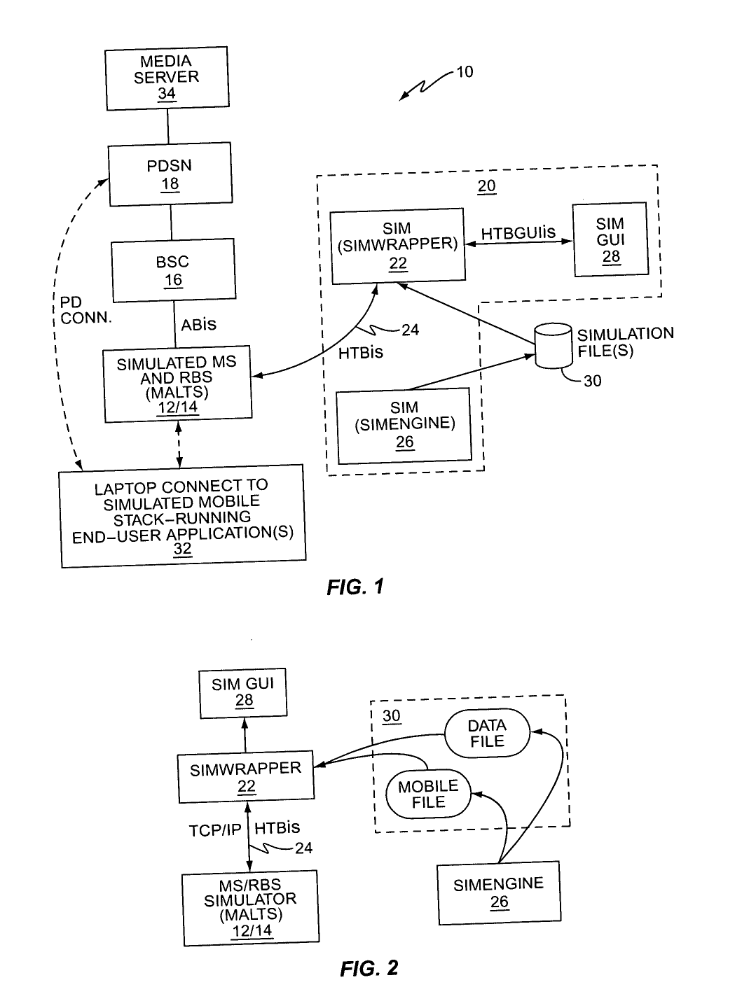

FIG. 1 is a diagram of a hybrid test bed 10 according to one or more embodiments of the present invention. The word “hybrid” highlights the mix of actual and simulated entities within test bed 10. For example, the illustrated test bed 10 comprises a radio base station simulator 12, a mobile station simulator 14, an actual Base Station Controller (BSC) 16, an actual Packet Data Serving Node (PDSN) 18, and a simulation controller 20, including a “Simulation Wrapper” 22 (also referred to as “SIMWRAPPER” herein), which has a simulation control interface 24 to the radio base station simulator 12, a “Simulation Engine” 26 (also referred to as “SIMENGINE” herein), and a “Simulation Graphical User Interface” 28 (also referred to as a “SIMGUI” herein). Note that the combination of simulated radio base stations 12 and simulated mobile stations 14 is referred to as “MALTs” 12/14 herein.

In one or more embodiments, the hybrid test bed 10 thus mixes simulated and actual wireless communication network entities in a real-time packet data simulation. In at least one embodiment, the test bed 10 supports end-to-end simulation for a packet data application running on the mobile station simulator 14. The test bed 10 provides a realistic assessment of that application's real-time performance by constraining packet data transmissions from the radio base station simulator 12 to the mobile station simulator 14 according to peak data throughput estimates and mobility event processing determined from a detailed wireless communication network simulation.

In one or more embodiments, the simulation controller 20 is configured to read detailed air interface simulation data from one or more stored data files 30. Those data files included detailed radio link performance data, such as a sequence of peak data throughput estimates made at timed intervals for a hypothesized path of travel by a mobile station in a wireless communication network simulation. The peak data throughput estimates thus reflect the realistic constraints imposed by the radio propagation channels, radio sector coverage areas, fading conditions, etc., corresponding to the path of travel modeled for the mobile station in the simulated wireless communication network. Those constraints can then be used to estimate the real-world performance of the packet data application being executed by the mobile station simulator 14, since data rates between the radio base station simulator 12 and the mobile station simulator 14 via the simulated air interface can be constrained according to the peak data throughput estimates, which reflect detailed radio link performance models.

Note that the mobile station simulator 14 may comprise an appropriately configured computer 32, or may be associated with a laptop or other Personal Computer (PC) that is configured to run one or more packet data applications of interest. Further, an actual IP-based media server 34 can be used to “anchor” the other end of the packet data application(s) running at the mobile station simulator 14. That arrangement tests the end-to-end flow of packet data between the media server 34, including the packet data handling of the actual PDSN 18 and the actual BSC 16, including any Packet Control Function (PCF) that is included in the BSC 16, or associated with it.

FIG. 2 focuses on the interconnection between the simulation controller 20 and the radio base station simulator 12 via the simulation control interface 24. FIG. 2 further illustrates that the SIMENGINE 26 may be configured to generate detailed radio link simulation files 30, such as a mobile station file and mobility event data file. Information in these files details radio link performance constraints and mobility events estimated over a desired time frame for a hypothesized travel path within a wireless communication network simulation having a defined number of base stations, radio sector coverage areas, radio channel models, etc.

For example, Table 1 below illustrates an exemplary format for a mobile station “data” file characterizing peak data throughput estimates for the Forward link Packet Data Channel (F-PDCH) of an IS-2000 network.

TABLE 1
A Mobile Station Data File Example.

| | F-PDCH | | N_EP Size | | | | | | | |
|---|---|---|---|---|---|---|---|---|---|---|
| MS | Serving | FirstSlot | (16 columns range: 0, 408, | | | LastSeqNum | | | PeakThroughput | |
| Index | Sector | (0 . . . 15) | 792, 1560, 2328, 3096, 3864) | | | (16 Columns) | | | (16 Columns) | |
| 1 | 2 | 0 | 0 | 4 | . . . | 0 | 1 | . . . | 0 | . . . |
| | | | | 0 | . . . | | | . . . | | . . . |
| | | | | 8 | | | | | | |

The above data embodies a sequence of peak data throughput estimates given at a defined time interval, e.g., 20 ms, representing constraints on the packet data transmission rate of the F-PDCH based on detailed radio link modeling. These (20 ms) time steps generally correspond to calculated radio link performance corresponding to the movement of mobile stations along hypothesized paths of travel “within” a simulated wireless communication network having a defined placement of radio base stations that provide characterized radio coverage within the simulation environment.

Estimates in the above table generally are based on a full-buffer transmission scenario, wherein the data throughput estimates are based on the assumption of there always being data to transmit. Therefore, to the extent that the estimated throughputs fall short of the maximum theoretical data rates available on the F-PDCH, they reflect the modeled radio link conditions and thus introduce “real-world” expectations in terms of the data transmission rates that would really be achievable. These more realistic data rates will mimic what can be expected in the actual wireless communication network to the extent that the radio link modeling accurately reflects radio coverage in the actual geographic regions modeled.

The stored simulation files may also include a mobility event data file that identifies mobility-related event information corresponding to the hypothesized path of travel as used for generating the peak data throughput estimates. The information in this file aids realism by providing, for example, information about the simulated mobile stations' active sets (serving sector radio base stations and serving sector candidate radio base stations), soft handoff conditions, softer handoff conditions, base station handoff events, etc. Mobility event information also may be generated at 20 ms intervals, or at some other defined time interval. Table 2 below illustrates typical mobility event information to aid simulation realism while evaluating real-time packet data performance over the end-to-end link:

TABLE 2
A Mobility Event Data File Example.

| | | | | Radio Access | ActiveSet |
|---|---|---|---|---|---|
| MS | Location (X | Location (Y | Traffic | Bearer (RAB) | ([1 . . . 6] |
| Index | Coordinate) | Coordinate) | Type | Type | numbers) |
| 1 | 3500 | 5600 | 3 | 12 | 2 3 4 |

In the above table, which can have multiple entries for tracking multiple mobile station simulations, the coordinate information represents meter offsets, for example, relative to a coordinate reference within the simulated network's geographic coverage region. Further, the traffic type can be a numeric representation of traffic type, as can the RAB Type indicator. Finally, the ActiveSet designators can be numerical identifiers corresponding to the particular radio base stations (or base station sectors) within the simulated wireless communication network that are candidates for serving the mobile station on the F-PDCH at each given simulation time interval. (The set typically changes as the mobile station “moves” along the simulated path of travel.)

Notably, if the SIMENGINE 26 is configured to carry out the detailed air interface simulation, it can do so in advance of evaluating the real-time performance of the packet data application running on the mobile station simulator 14. That is, the SIMENGINE 26 can be configured to perform a non-real-time simulation of radio service to one or more mobile stations according to a simulated wireless communication network, collect data throughput and mobility event data from that detailed simulation, store the collected data. The SIMENGINE 26 then imposes realistic constraints on the real-time delivery of packet data between the radio base station simulator 12 and the mobile station simulator 14 by playing back that information in real time via the simulation control interface 24.

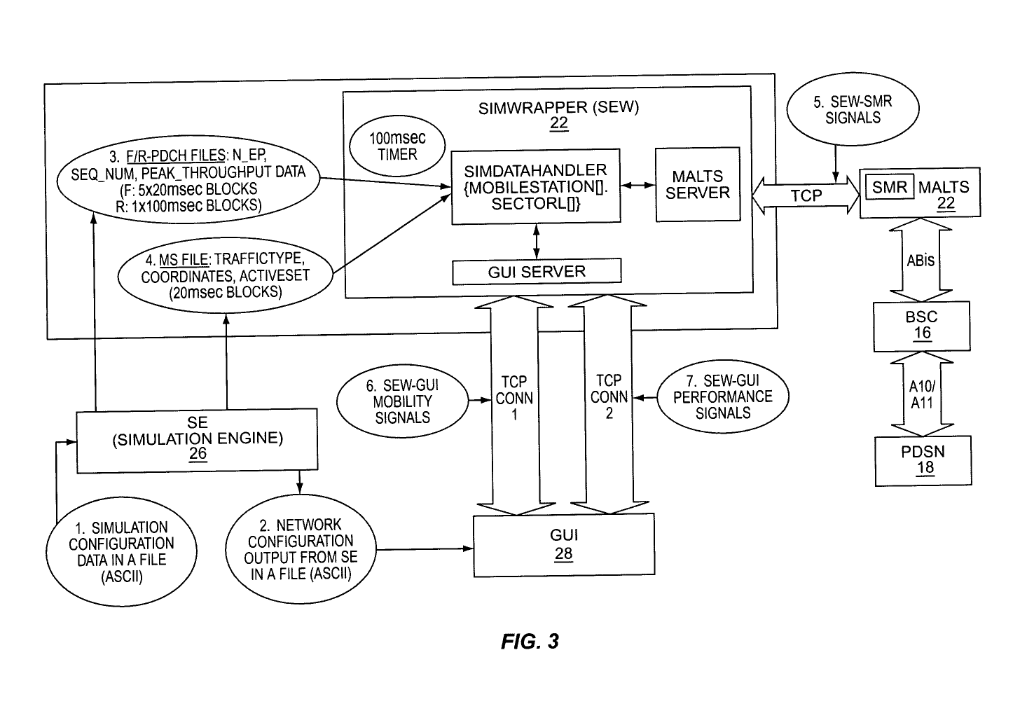

The above approach allows the detailed, and typically time-consuming radio link simulations to be performed off-line, thereby allowing the relevant performance constraining data—e.g., the peak data throughput limitations and the mobility events—to be pre-calculated in advance of real-time simulation and then played back in real-time. FIG. 3 illustrates one method of real-time simulation control according to this embodiment of the present invention.

Item (1) in FIG. 3 comprises a Simulation Configuration File that can be used to control the simulation run time, etc. The Simulation Configuration File, which may be in ASCII format, provides simulation input information to the SIMENGINE 26. In one or more embodiments that information includes some or all of the following items: NumRBSs (the number of RBSs in the simulated network environment), NumSectorPerRBS (the number of sectors per RBS), NumMobilesForVoice (the number of voice-user mobile stations in the simulation), NumMobilesForData (the number of data-user mobile stations in the simulation), Speed (the moving speed of the mobile stations), SimulationLength (the running time of the simulation), and LoggingInfo (the type/amount of data to be logged during simulation).

Item (2) comprises a Network Configuration File (or data stream) from the SIMENGINE 26. The Network Configuration File, which may be in ASCII format, provides simulation input information to the SIMENGINE 26. In one or more embodiments that information includes some or all of the following items: NumRBSs as above, NumSectorPerRBS as above, CoordRBS (the geographic or simulation space coordinates of each RBS), SectorID (the sector IDs and associated RBS IDs), RadSector (the radius of each sector), NameSector (the sector names), AntDirection (the antenna direction(s) for each sector), and WrapAround data.

Item (3) comprises Forward and/or Reverse link packet data channel files (F/R-PDCH data), includes sequences of peak data throughput estimates corresponding to a detailed air interface simulation for one more mobile stations and a given simulated wireless communication network configuration, which can be identified for the Simulation GUI 28 via the aforementioned Network Configuration File. In one or more embodiments the F-PDCH data file contains data on the F-PDCH, in 20 millisecond blocks, for example, for all PDCH users being simulated by the SIMENGINE 26. Table 1 above shows PDCH file data used in one or more embodiments, with one row corresponding to a simulated mobile station assigned an index value of 1—it should be understood that the table would have a row of like data entries for each simulated mobile station engaged in PDCH service. Similarly, the R-PDCH data file contains data on the R-PDCH, in 100 millisecond blocks, for example, for all simulated mobile stations engaged in R-PDCH service.

Item (4) comprises a Mobile Station (MS) File, including traffic type, location coordinates, active set information, etc., along with any other mobility-related information of interest for the simulation. The MS file includes data for all users (data and voice) being simulated by the SIMENGINE 26. The MS File, which may be in ASCII format, provides simulation input information to the SIMENGINE 26. Table 2 above illustrates a layout for the MS file used in one or more embodiments, and it should be understood that the illustrated data items would exist for each mobile station included in a given simulation run. In one or more embodiments that information includes some or all of the following items: the number of voice user and data user mobile stations being simulated, and, for each mobile station, the X and Y coordinate locations, the traffic type (e.g., 1=Markov Voice, 2=SMV, 3=Full-Buffer Data, 4=IP Data, 5=HTTP data), radio access bearer type (e.g., 1=FCH Voice, 2=PDCH Data), and active set sector IDs identifying the mobile station's Active Set of sectors.

Item (5) comprises the TCP-based signals flowing between the SIMWRAPPER 22 and the RBS simulator 12 via the simulation control interface 24. Item (6) comprises the mobility-related signaling between the Simulation GUI 28 and the SIMWRAPPER 22, and Item (7) comprises essentially the same thing, but for performance-related data useful in presenting performance-related information on the Simulator GUI 28 for the packet data application running in real-time on the mobile station simulator 14.

With the above in mind, then, the SIMWRAPPER 22, which generally comprises simulation software running on a microprocessor-based circuit, such as an appropriately configured Unix workstation or Personal Computer. Regardless of the particular platform on which it is implemented, the SIMWRAPPER 22 in one or more embodiments of the hybrid test bed 10 controls the real-time simulation start, stop, and pause, maintains one or more timers for the real-time simulation, and invokes a SimDataHandler according to a desired timing interval.

The SimDataHandler within the SIMWRAPPER 22 creates and keeps a list of mobile station objects and radio sector objects, and receives and handles timer events, e.g., 100 ms timer interrupts, and signals from the Simulation GUI 28 and the radio base station simulator 12. The SimDataHandler can be configured to perform the following event handling tasks responsive to a 100 ms timer, for example:
Read the next 100-millisecond data block from the mobile station file (4. MS File);
Read the next 100 millisecond data block from the Forward and Reverse link PDCH files;
Build the active set change signal;
Build the cell switch change signal;
Send the previous PDCH signal, active set change signal, and cell switch change signals from the SIMWRAPPER 22 to the RBS simulator 12;
Build the next 100 millisecond command signal (the PDCH signal for the next interval);
Check whether the real-time simulation is at a performance data update interval—if so, send updated performance information for the real-time simulation from the SIMWRAPPER 22 to the Simulation GUI 28—this can be done at one second intervals for example to maintain a live real-time performance display for the packet data application as it runs on the mobile station simulator 14; and
Check whether the real-time simulation is at a mobility update interval-if so, send mobility event information from the SIMWRAPPER 22 to the Simulation GUI 28, thereby allowing it to update its serving sector and/or active set information, etc.—this can be done at five second intervals, for example.

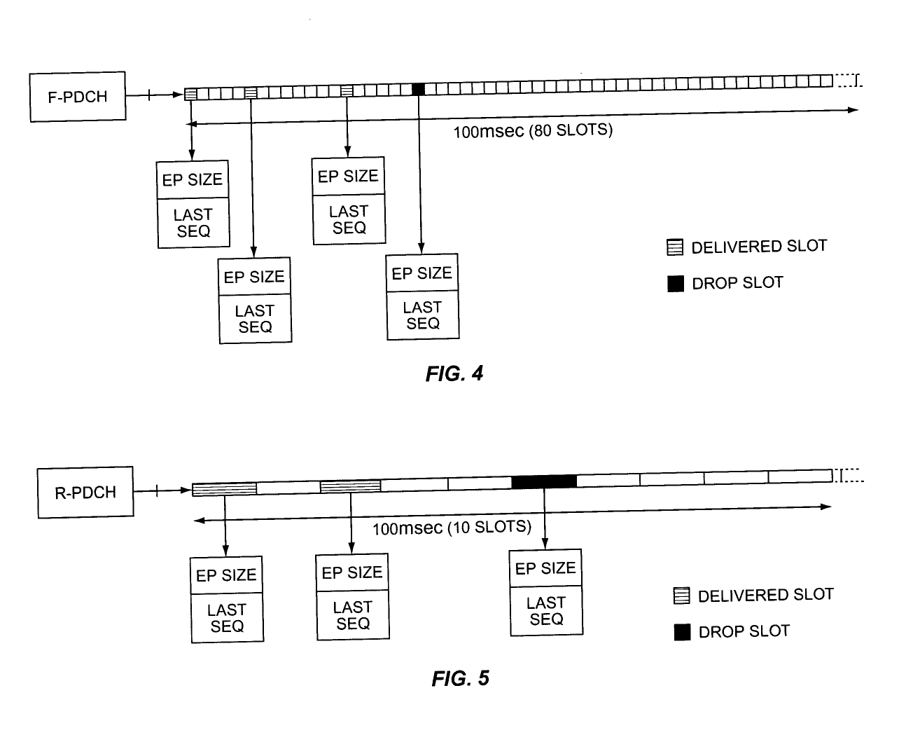

FIGS. 4 and 5 illustrate real-time operation of the simulated F-PDCH and R-PDCH links between the radio base station simulator 12 and the mobile station simulator 14, for a given 100-millisecond interval of the real-time simulation. More particularly, FIG. 4 illustrates delivered and dropped packet data slots on the simulated forward and reverse packet data links as determined by the packet size, sequence number, and throughput estimation information being sequentially read out from the F/R-PDCH files by the SIMWRAPPER 22. In other words, the SIMENGINE 20 reads the previously estimated peak data throughputs, packet size information, etc., that was generated by the prior off-line, detailed simulation, and uses that information to constrain packet data delivery on the simulated F/R-PDCH during the real-time simulation. Doing so makes the performance of the packet data application running on the mobile station simulator 14 better mimic what might be expected in the actual wireless communication network being modeled by the detailed simulation.

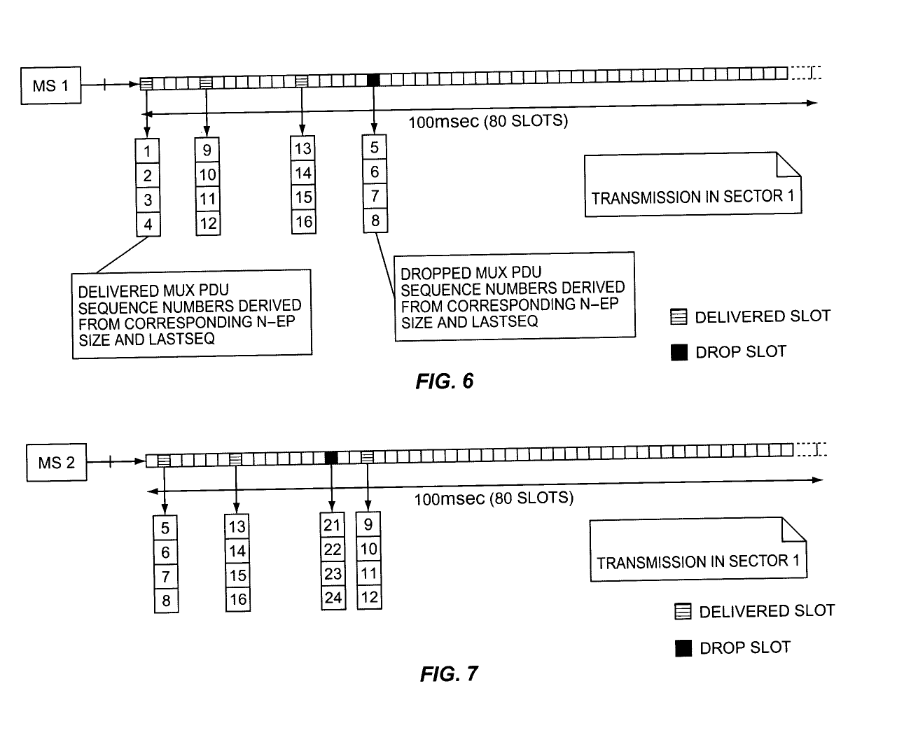

FIGS. 6 and 7 illustrate delivered and dropped radio base station (multiplexed) Packet Data Units (PDUs) for two simulated mobile stations (MS1 and MS2), where delivering and dropping actions are controlled according to the PDCH packet size values computed in the detailed radio simulation (N_EP Size), and the corresponding packet sequence numbers. Thus, the detailed simulation determines deliverable packet sizes for a sequence of F/R-PDCH slots as a function of simulated radio conditions, etc., and those constraints are then used by the real-time—simulation to mimic realistic packet data channel performance by selectively delivering or dropping packet data. This can be done for each mobile station being simulated in real-time—assuming corresponding off-line information was developed for the mobile station—and can be done on a per-sector basis.

In more detail, the parameter N_EP size refers to an “Encoder Packet” size. In the simulation system, EncoderPackets, also referred to as EPs, comprise one or more “multiplex Packet Data Units” (muxPDUS). Each muxPDU is fixed size of 384 bits in one or more embodiments. An EP can then contain 1, 2, 4, 6, 8 or 10 muxPDUs. Each EP also has a number of bits for the EP header. Resulting EP sizes are 408, 792, 1560, 2328, 3096, or 3864 and contain either 1, 2, 4, 6, 8, or 10 muxPDUs, respectively.

In 1x cdma2000 systems, BSCs transmit muxPDUs to RBSs over the backhaul (abis) interface. Each muxPDU is tagged with a Sequence number that corresponds to Radio Link Protocol (RLP) sequence numbers used by the BSC and the mobile stations to determine which packets were received in which order. Such packet sequence numbering enables the re-assembly of ordered packets and provides a basis for detecting dropped packets, which can then be “NACKed” to trigger their retransmission.

An RBS Cell Site Modem (CSM), which generally is implemented as a complex Application Specific Integrated Circuit (ASIC) in actual RBSs, packets the muxPDUs into EPs and transmits them to the mobile stations. The SIMENGINE 26 instructs the simulator to deliver EPs with specific sizes and corresponding to muxPDUs where the sequence number of the last muxPDU in the EP is “LastSeqNum,” as seen in Table 1, for example. In turn, the SIMWRAPPER 22 uses the file(s) represented by Table 1 to generate periodic command signals to the MALTs 12/14 to instruct like in FIG. 6. In one embodiment, the SIMWRAPPER 22 sends commands to the MALTS 12/14 at 100 millisecond intervals. These periodic command signals tell the MALTS 12/14 which muxPDUs will be transmitted/received for a given simulated mobile station and which muxPDUs will be “dropped” for that simulated mobile station, as is shown for mobile stations 1 and 2 (MS1 and MS2) in FIGS. 6 and 7.

More particularly, the SIMWRAPPER 22 sends two types of signals to the MALTS 12/14. The first type, the periodic command signals described above, contain data developed from or corresponding to the detailed radio simulation that tell the MALTS 12/14 which muxPDUs to deliver and which muxPDUs to drop in specified 1.25 millisecond intervals for the mobile stations being simulated.

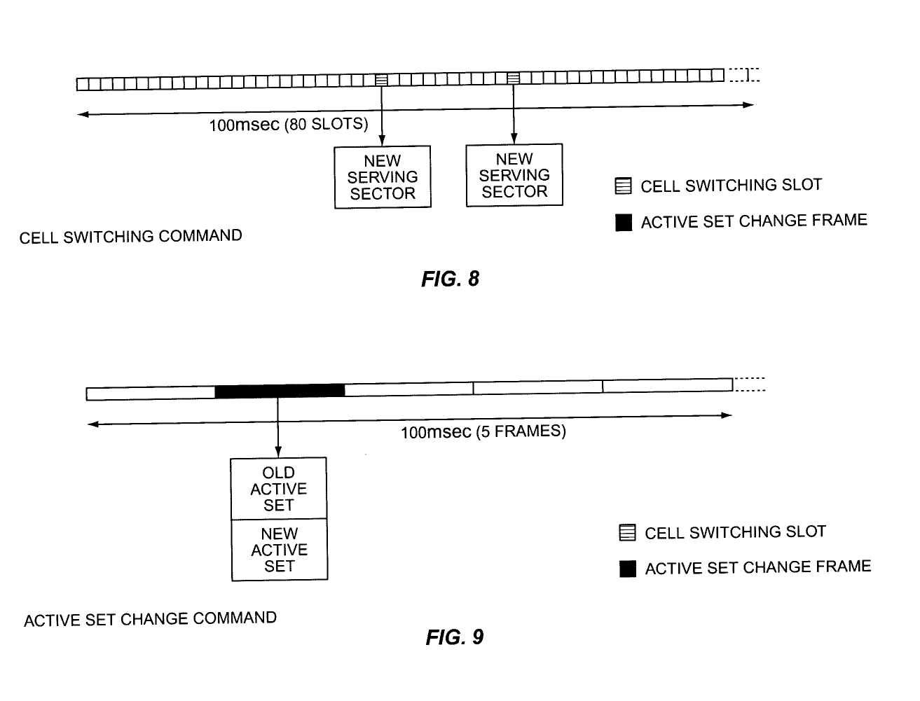

A second type of signal sent by the SIMWRAPPER 22 to the MALTS 12/14 is also based on the detailed radio simulation, and is used to tell the MALTS 12/14 when to simulate a mobile station performing an Active Set Change or a Cell Switch between two RBSs. FIGS. 8 and 9 and illustrate mobility management simulation based on the SIMWRAPPER 22 providing mobility-event command data to the MALTS 12/14 on a periodic command basis. For example, FIG. 8 shows new serving sector selections—in IS-2000 based simulations for cdma2000-based networks, this represents autonomous serving sector reselection by the mobile stations in the detailed radio simulation environment, which is driven by modeled pilot signal strengths, for example.

Similarly, FIG. 9 illustrates active set changes, wherein mobile stations' active set of serving and candidate sectors changes as a function of changing received pilot signal strengths in the detailed simulation environment. This information can be used to “burden” the real-time simulation, so that the performance of the packet data application being simulated realistically reflects mobility event processing overhead.

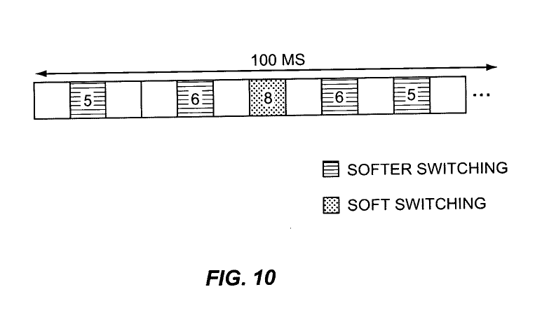

FIG. 10 illustrates yet another mobility-event information component that can be used to influence the real-time packet data simulation, wherein the soft and softer handoff conditions are illustrated for a given simulated mobile station, for a given 100 millisecond window of time. Thus, the SIMWRAPPER 22 can drive soft/softer handoff mobility events for the MALTS 12/14 simulation of RBSs and mobile stations. As used herein, “softer” handoff denotes serving a mobile station on two or more radio links at the same cell site. For example, a softer handoff condition on the reverse link occurs where two or more radio sectors at the same (simulated) radio base station are in a (simulated) mobile station's active set and have reverse radio links with that mobile station.

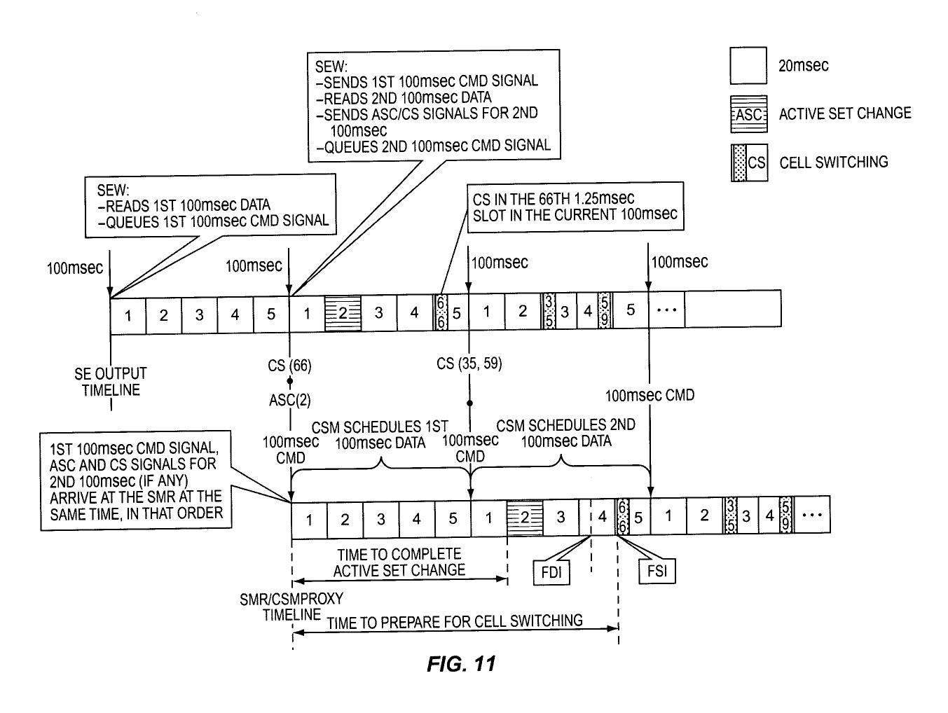

FIG. 11 further details mobility event processing for the SIMENGINE (SE) timeline. More particularly, the illustration demonstrates a “look-ahead” mechanism used by the SIMWRAPPER 22 to assist in active set changes and cell switching during the real-time simulation. The illustrated operation effectively guarantees advance notification, e.g., 100 ms advance notification with a 100 ms command timer, of future active set changes and/or cell switching by the mobile stations being simulated via the MALTS 12/14. It is assume that, for each simulated mobile station, active set changes happen no more frequently than once per 100 ms, and that such changes occur at 20 ms frame boundaries. Similarly, cell switching for a simulated given mobile station is assumed to occur no more than once per 20 ms frame, but such switching can happen at any 1.25 ms slot of each 20 ms frame.

Of course, those skilled in the art will appreciate that the hybrid test bed's configuration can be based on other timing assumptions, and that mobility event processing, as with other aspects of the hybrid test bed's operation, can be changed as needed or desired. Further, those skilled in the art should be understand that the above mobility-event and packet data throughput information does not have to be calculated off-line in advance of carrying out the real-time simulation on the hybrid test bed 10.

Indeed, in one or more embodiments of the present invention, the SIMENGINE 20 is configured to calculate such data in real-time, which may be referred to as “on-the-fly” computation. In that configuration, the real-time simulation being carried out on the hybrid test bed 10 really involves two simulations running in parallel: a real-time simulation of the end-to-end performance of a packet data application via the simplified air interface simulation communicatively coupling the radio base station simulator 12 with the mobile station simulator 14, and the supporting real-time simulation of a detailed air interface for a given simulated network configuration. The detailed air interface simulation results are used by the SIMENGINE 20 to constrain the simplified air interface link of the real-time simulation, so that the packet data application being simulated in real-time reflects more realistic network performance limitations.

Thus, whether the detailed radio link and mobility simulation is performed off-line in advance of the real-time simulation, or on-the-fly in parallel with the real-time simulation, the present invention provides a method of realistically simulating the end-to-end performance of a packet data application in real-time for a wireless communication network. More particularly, one embodiment, the present invention comprises a method based on sending packet data between the actual PDSN 18 and the simulated mobile station 14 to support a packet data application running in real-time on the simulated mobile station 14, and constraining transmission of the packet data over a simulated air interface between the simulated radio base station 12 and the simulated mobile station 14 according to peak data throughput estimates and mobility events determined for a defined path of travel within a simulated wireless communication network.

Doing so allows testing and verification of the actual BSC 16 and the actual PDSN 18, even if actual radio base station or mobile station hardware is unavailable. For example, actual radio base stations and mobile stations typically use sophisticated cell-side and mobile-side “modems” to manage their respective radio links, and such devices may not be available in final-form hardware until late in the system development cycle. Thus, the present invention enables hybrid testing of a mix of real and simulated parts to happen before one or both the cell-side and mobile-side modems are available for evaluation by simulating a mobile-side modem in the mobile station simulator 14 and simulating a cell-side modem in the radio base station simulator 12, as needed.

Typically, Verilog, VHDL, or some other hardware design language is used to develop the hardware logic used in such modems, which oftentimes are implemented as Application Specific Integrated Circuits (ASICs), and thus their operation can be mimicked using that same code, or corresponding program instructions in another computer language, so that an appropriately configured computer can mimic the modem behavior as needed. Of course, the upside of simulating these modems using their actual design code is that the real-time simulation exercises the code and can reveal problems that otherwise might not be caught until actual modem hardware is available.

In any case, the present invention broadly provides for the realistic simulation of an end-to-end packet data application based on detailed radio link modeling, whether that modeling is done on the fly during the real-time simulation, or done offline in advance of the real-time simulation. The hybrid test bed of the present invention mixes actual and simulated network entities and provides graphical performance data demonstrating the packet data application performance that can realistically be expected for a given wireless communication network configuration.

As such, the present invention is not limited by the foregoing discussion and its detailed examples, nor is it limited by the drawings. Instead, the present invention is limited only by the following claims and their reasonable legal equivalents.

What is claimed is:

1. A method of realistically simulating the end-to-end performance of a packet data application in real-time for a wireless communication network, the method comprising:
running a packet data application in real-time on a mobile station simulator that is coupled to a radio base station simulator through a simulated air interface;
coupling the radio base station simulator through an actual base station controller to an actual packet data server supporting the packet data application in real-time; and
imposing realistic performance constraints on the simulated air interface by constraining real-time packet data transmissions from the radio base station simulator for the packet data application according to detailed air interface simulation data.

2. The method of claim 1, wherein imposing realistic performance constraints on the simulated air interface by constraining real-time packet data transmissions from the radio base station simulator for the packet data application according to detailed air interface simulation data comprises constraining the real-time packet data transmissions from the radio base station simulator according to sequences of peak data throughput estimates and mobility events corresponding to movement by the mobile station along a hypothesized path of travel within a wireless communication network simulation that incorporates a defined radio base station layout and corresponding radio propagation channel models.

3. The method of claim 2, further comprising generating the sequence of peak data throughput estimates for the mobile station by estimating packet data throughput to the mobile station at timed intervals corresponding to its movement along the hypothesized path of travel for a full-buffer data transmission scenario.

4. The method of claim 2, further comprising generating the sequences of peak data throughput estimates and mobility events over a desired simulation interval corresponding to a desired real-time simulation run time.

5. The method of claim 2, wherein constraining the real-time packet data transmissions from the radio base station simulator according to sequences of peak data throughput estimates and mobility events comprises controlling transmission times and transmission data rates of the radio base station simulator in real-time according to the sequences of peak data throughput estimates and mobility events.

6. The method of claim 5, further comprising generating the sequences of peak data throughput estimates and mobility events based on time intervals between about 10 milliseconds and about 100 milliseconds.

7. The method of claim 1, wherein running a packet data application in real-time on a mobile station simulator that is coupled to a radio base station simulator through a simulated air interface includes simulating a mobile-side modem in the mobile station simulator and simulating a cell-side modem in the radio base station simulator.

8. The method of claim 7, wherein simulating a mobile-side modem in the mobile station simulator and simulating a cell-side modem in the radio base station simulator comprises executing simulation program instructions corresponding to a hardware-based implementations of the cell-side and mobile-side modems.

9. A hybrid test bed mixing actual and simulated wireless communication network entities, and realistically simulating the end-to-end performance of a packet data application in real-time for a wireless communication network, the hybrid test bed comprising:
a mobile station simulator configured to run a packet data application in real-time;
a radio base station simulator communicatively coupled to the mobile station simulator through a simulated air interface;
an actual base station controller communicatively coupled to the radio base simulator and communicatively coupled to an actual packet data server configured to support the packet data application in real-time; and
a simulation controller communicatively coupled to the radio base station simulator via a simulation control interface and configured to impose realistic performance constraints on the simulated air interface by constraining real-time packet data transmissions from the radio base station simulator for the packet data application according to detailed air interface simulation data.

10. The hybrid test bed of claim 9, wherein the simulation controller is configured constrain the real-time packet data transmissions from the radio base station simulator according to sequences of peak data throughput estimates and mobility events corresponding to movement by the mobile station along a hypothesized path of travel within a wireless communication network simulation that incorporates a defined radio base station layout and corresponding radio propagation channel models.

11. The hybrid test bed of claim 10, wherein the simulation controller is configured to read the sequences of peak data throughput estimates and mobility events from one or more off-line simulation files.

12. The hybrid test bed of claim 10, wherein the simulation controller is configured to generate the sequence of peak data throughput estimates for the mobile station by estimating packet data throughput to the mobile station at timed intervals corresponding to mobile station movement along the hypothesized path of travel for a full-buffer data transmission scenario.

13. The hybrid test bed of claim 10, wherein the sequences of peak data throughput estimates and mobility events span a defined simulation interval corresponding to a desired real-time simulation run time.

14. The hybrid test bed of claim 10, wherein the simulation controller constrains the real-time packet data transmissions from the radio base station simulator according to sequences of peak data throughput estimates and mobility events by controlling transmission times and transmission data rates of the radio base station simulator in real-time according to the sequences of peak data throughput estimates and mobility events.

15. The hybrid test bed of claim 14, wherein the sequences of peak data throughput estimates and mobility events are generated at time intervals of between about 10 milliseconds and about 100 milliseconds.

16. The hybrid test bed of claim 9, wherein the mobile station simulator includes a mobile-side modem simulator, and wherein the radio base station simulator includes a cell-side modem simulator.

17. The hybrid test bed of claim 16, wherein the mobile-side and cell-side modem simulators comprise one or more microprocessor-based circuits executing computer program instructions corresponding to hardware-based implementations of actual cell-side and mobile-side modems.

18. A method of realistically simulating the end-to-end performance of a packet data application in real-time for a wireless communication network, the method comprising:
sending packet data between an actual Packet Data Serving Node and a simulated mobile station to support a packet data application running in real-time on the simulated mobile station; and
constraining transmission of the packet data over a simulated air interface between a simulated radio base station and the simulated mobile station according to peak data throughput estimates and mobility events determined for a defined path of travel within a simulated wireless communication network.
